(19) United States
(12) Patent Application Publication
(10) Pub. No.: US 2023/0253840 A1
(43) Pub. Date: Aug. 10, 2023

(54) Screw Connection, Electric Machine and Motor Vehicle Drive Unit

(71) Applicant: ZF Friedrichshafen AG, Friedrichshafen (DE)

(72) Inventors: Michael Griesbach, Tettnang (DE); Thorsten Müller, Friedrichshafen (DE)

(21) Appl. No.: 18/011,967

(22) PCT Filed: Jun. 17, 2021
(86) PCT No.: PCT/EP2021/066327

§ 371 Date: Dec. 21, 2022

(30) Foreign Application Priority Data
Jun. 24, 2020 (DE) 10 2020 207 815.7

(51) Int. Cl. H02K 1/18; H02K 5/08

(52) U.S. Cl. CPC H02K 1/185; H02K 5/08

(57) ABSTRACT

A screw connection (SV) between a stator (S) of an electric machine (EM) and a housing (GG) includes a screw (SS). A shank (SS2) of the screw (SS) is at least partially encompassed by an electrically insulating sleeve (SH). A diameter of the thread (SS3) of the screw (SS) is greater than an inner diameter of the sleeve (SH).

### CROSS-REFERENCE TO RELATED APPLICATIONS

The present application is related and claims priority to 102020207815.7 filed in the German Patent Office on Jun. 24, 2020 and to PCT/EP2021/066327 filed in the European Patent Office on Jun. 17, 2021, both of which are incorporated by reference in their entirety for all purposes.

### FIELD OF THE INVENTION

The invention relates generally to a screw connection between a stator of an electric machine and a housing. The invention further generally relates to an electric machine that includes a screw connection of this type, and to a drive unit for a motor vehicle, the drive unit including an electric machine of this type.

### BACKGROUND

Patent application FR 2 115 648 A5 describes a configuration for an electrically driven pump. The electric motor of the pump includes a stator, which is secured at a housing by screws. The screws are encompassed by a tubular body, in order to electrically insulate the stator with respect to the housing.

This type of configuration results in an increased amount of assembly work. This is the case because the tubular bodies must first be inserted into the openings in the stator. Only thereafter can the screw connection of the stator be established.

### SUMMARY OF THE INVENTION

Example aspects of the present invention provide a screw connection that ensures an electrical insulation and, in addition, reduces the amount of assembly work.

A screw connection between a stator of an electric machine and a housing is provided. The screw connection has a screw that includes a screw head, that includes a shank adjoining the screw head, and that includes a thread adjoining the shank. The shank is enclosed by an electrically insulating sleeve at least partially or in sections.

According to example aspects of the invention, a diameter of the thread is greater than an inner diameter of the sleeve. Due to the greater thread diameter in relation to the inner diameter of the sleeve, the thread forms a loss prevention for the sleeve. The screw connection of the stator at the housing is therefore considerably simplified, since the sleeves have already been captively secured on the screws.

Preferably, the sleeve has an open cross-section. As a result, the sleeve can be mounted onto the shank only after the thread has been produced. As a result, chips arising during the thread production can be prevented, in an easy way, from remaining between the shank and the sleeve. In addition, the screw including the finished thread can be heat-treated, in order to improve the strength of the screw. If the sleeve is mounted onto the shank only after the heat treatment, the sleeve does not need to be made of a high-temperature resistant material.

Preferably an electrically insulating spacer is associated with the screw head. The spacer has a through-hole, wherein the shank has been guided through the through-hole. Due to the spacer, an electrical insulation is ensured between the screw head and the abutting surface of the screw connection associated with the screw head.

Preferably, the spacer and the sleeve are separate components, which are preferably made of different materials. The sleeve can be made, for example, of polyamide or of polyphenylene sulfide. These plastics are simple to produce and are distinguished by a high temperature resistance and, thus, are well suited for use in the stator screw connection. The spacer is preferably made of ceramic or a high-pressure resistant plastic. These materials have good electrical insulation and, due to the pressure resistance of the materials, adversely affect the seating property of the screw connection only to a minor extent.

Preferably, the spacer has an axially aligned projection, which is aligned in the direction of the screw head. With a configuration of this type, the spacer can be secured at the screw head, so that a loss prevention of the spacer is ensured.

Alternatively, a further sleeve can be provided, which encompasses the screw head and the spacer at least partially or in sections. With a configuration of this type as well, the spacer can be secured at the screw head, in order to ensure a loss prevention of the spacer.

According to another alternative example embodiment, an outer diameter of the sleeve encompassing the shank is greater than an inner diameter of the through-hole of the spacer. As a result, the spacer is held by the sleeve on the screw. An additional loss prevention for the spacer can be dispensed with.

The screw connection described at the outset can be an integral part of an electric machine that includes a housing. The electric machine includes a rotationally fixed stator and a rotatably mounted rotor, wherein the stator is arranged within the housing. The stator is connected to the housing by the screw connection described at the outset. Preferably, the screw connection is aligned axially parallel to an axis of rotation of the rotor.

The electric machine can be an integral part of a drive unit for a motor vehicle, the electric machine being configured for driving the vehicle. For example, the electric machine can be an integral part of an axle that includes an electric drive. Alternatively, the electric machine can be an integral part of a hybrid module, which is arranged in the motor vehicle drive train between the internal combustion engine and the transmission, or between the transmission and the drive axle. According to another alternative example embodiment, the electric machine can be an integral part of a transmission in the motor vehicle drive train.

### BRIEF DESCRIPTION OF THE DRAWINGS

Exemplary embodiments of the invention are described in detail with reference to the figures, wherein:

FIG. 1a through FIG. 1d show various configurations of a motor vehicle drive train;

FIG. 2 shows a schematic sectioning of a motor vehicle drive unit;

FIG. 3a shows a view of a screw;

FIG. 3b shows a cross-section of a sleeve; and

FIG. 4a through FIG. 4c each show a detailed view of various exemplary embodiments of a screw connection.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

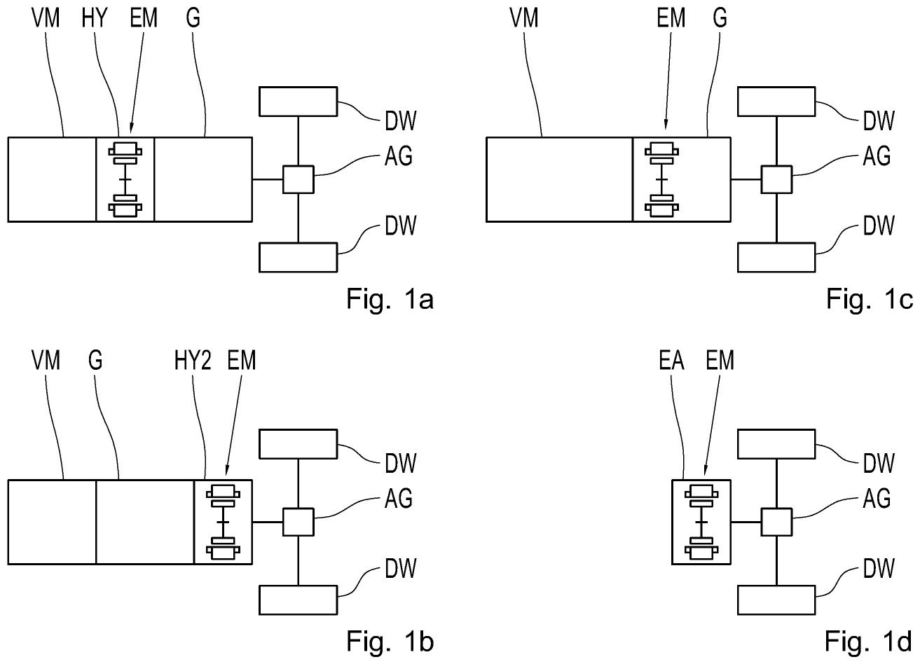

FIG. 1a shows a drive train of a motor vehicle. The drive train includes an internal combustion engine VM. The drive train includes a transmission G for adapting the rotational speed and torque output characteristics of the internal combustion engine VM to the driving resistances of the motor vehicle. The transmission G can be, for example, an automatic transmission, an automated transmission that includes one single launch clutch, a dual-clutch transmission, a CVT transmission, or a manually shifted transmission. The transmission G is connected, at the output end of the transmission G, to a differential gear AG, which distributes the drive power to driving wheels DW.

In the drive train according to FIG. 1a, a hybrid module HY is arranged between the internal combustion engine VM and the transmission G. The hybrid module HY includes an electric machine EM, by which the motor vehicle is drivable purely electrically or in a hybrid manner together with the internal combustion engine VM. The hybrid module HY can include a separating clutch (not shown in FIG. 1a), by which a torque transmission is engageable between the internal combustion engine VM and the electric machine EM.

FIG. 1b shows another configuration of a motor vehicle drive train. A hybrid module HY2 is provided in the motor vehicle drive train, the hybrid module HY2 being arranged at the output side of the transmission G, in contrast to the drive train according to FIG. 1a. The hybrid module HY2 also includes an electric machine EM, by which the motor vehicle is drivable purely electrically or in a hybrid manner together with the internal combustion engine VM.

FIG. 1c shows another configuration of a motor vehicle drive train. A hybrid module is not provided in the motor vehicle drive train. Instead, the electric machine EM is an integral part of the transmission G. A transmission G of this type is also referred to as a hybrid transmission.

FIG. 1d shows another configuration of a motor vehicle drive train, which, in contrast to the drive trains according to FIG. 1a through FIG. 1c, is a purely electric drive train without an internal combustion engine. An electric axle drive EA includes an electric machine EM, the drive power of which is distributed onto driving wheels DW of the motor vehicle via the differential gear AG. A drive train of this type could also include a transmission between the axle drive EA and the differential gear AG, for example, a 2-speed transmission. This type of electric axle drive EA could also be combined with a second axle that is driven by an internal combustion engine.

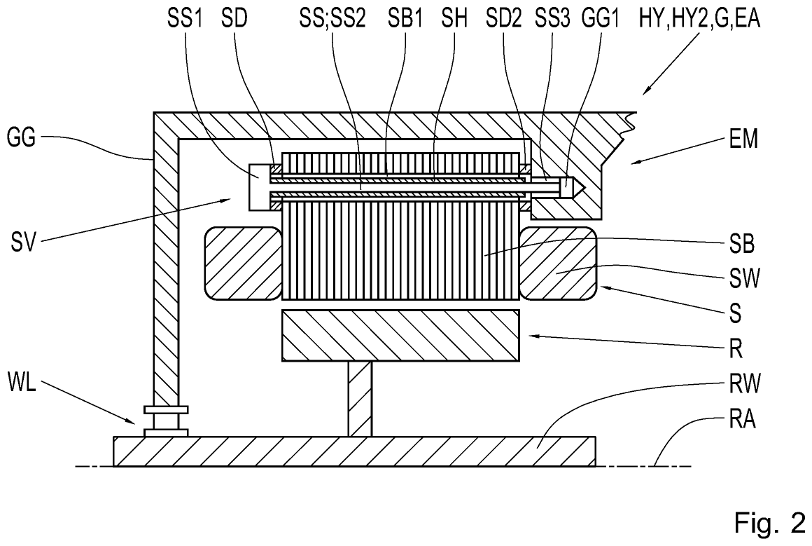

The hybrid modules HY, HY2, the hybrid transmission G, and the axle drive EA form drive units for the motor vehicle. FIG. 2 shows a schematic sectional view of a drive unit HY, HY2, G, EA of this type. The electric machine EM is arranged in a metallic housing GG and includes a rotationally fixed stator S and a rotor R. The rotor R is connected to a rotor shaft RW, which is mounted at the housing GG via a bearing WL. In this way, the rotor R, including the rotor shaft RW, can rotate about an axis RA.

The stator S includes a stator laminated core SB, at which at least one stator winding SW is arranged. The stator laminated core SB is secured at the housing GG via a screw connection SV, for example, via three screws SS. For this purpose, the stator laminated core SB has passage openings SB1, through which the screws SS are guided in the axial direction. Threaded holes GG1 are arranged in the housing GG, the threaded holes GG1 interacting with a thread SS3 of the screws SS. A shank SS2 of the screws SS is encompassed by an electrically insulating sleeve SH. The diameter of the thread SS3 is greater than an inner diameter of the sleeve SH, so that the sleeve SH is secured on the screw SS.

The stator S is electrically insulated with respect to the housing GG in order to reduce the transmission of interference currents starting from the stator S via the housing GG and via the bearing WL to the rotor shaft RW. For this purpose, electrically insulating spacers SD2 are arranged between the stator laminated core SB and the housing GG. These spacers SD are made, for example, of ceramic or a high-pressure resistant plastic. Electrically insulating spacers SD are arranged between a screw head SS1 of the screws SS and the stator laminated core SB.

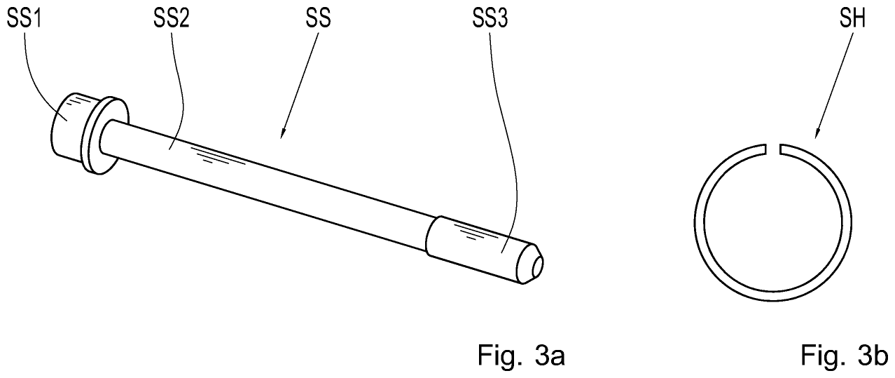

FIG. 3a shows a perspective view of the screw SS. The screw head SS1, the shank SS2, and the thread SS3 of the screw SS are apparent in this view. The diameter of the thread SS3 is greater than the diameter of the shank SS2.

FIG. 3b shows a cross-section of the sleeve SH. The sleeve SH has an open cross-section and, thus, can be mounted onto the shank SS2 also after the thread SS3 has been produced.

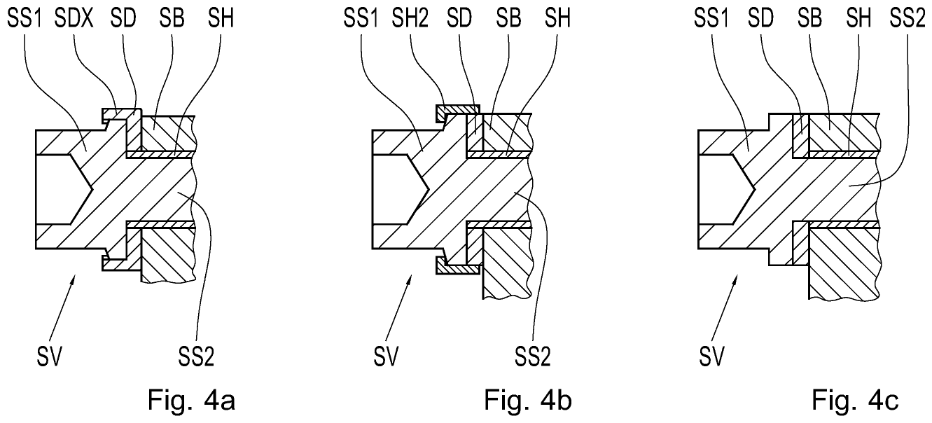

FIG. 4a shows a detailed view of the screw connection SV according to a first exemplary embodiment, the screw connection SV differing from the screw connection shown in FIG. 2. The spacer SD has an axially aligned projection SDX, which is aligned in the direction of the screw head SS1. Via this projection SDX, the spacer SD is secured at the screw head SS1, such that the spacer SD cannot slip, unobstructed, off the screw SS.

FIG. 4b shows a detailed view of the screw connection SV according to a second exemplary embodiment, the screw connection SV differing from the screw connection shown in FIG. 2. A further sleeve SH2 is provided in this case, which encompasses the screw head SS1 and the spacer SD at least partially or in sections. Via this further sleeve SH2, the spacer SD is secured at the screw head SS1, such that the spacer SD cannot slip, unobstructed, off the screw SS.

FIG. 4c shows a detailed view of the screw connection SV according to a third exemplary embodiment, the screw connection SV differing from the screw connection shown in FIG. 2. In this case, the sleeve SH does not extend up to the screw head SS1. A through-hole of the spacer SD is smaller than an outer diameter of the sleeve SH, such that the spacer SD cannot slip off the screw SS.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

VM internal combustion engine

HY hybrid module

HY2 hybrid module

G transmission

EA electric axle drive

AG differential gear

DW driving wheel

EM electric machine

S stator

SB stator laminated core

SB1 passage opening

SW stator winding

R rotor

RW rotor shaft

RA axis of rotation

WL bearing

GG housing

GG1 threaded hole

SV screw connection

SS screw

SS1 screw head

SS2 shank

SS3 thread

SH sleeve

SD spacer

SDX projection

SH2 further sleeve

SD2 spacer

1-11. (canceled)

12. A screw connection (SV) between a stator (S) of an electric machine (EM) and a housing (GG), comprising:
a screw (SS) comprising a screw head (SS1), a shank (SS2) adjoining the screw head, and a thread (SS3) adjoining the shank (SS2); and
an electrically insulating sleeve (SH) at least partially enclosing the shank (SS2),
wherein a diameter of the thread (SS3) is greater than an inner diameter of the sleeve (SH).

13. The screw connection (SV) of claim 12, wherein the sleeve (SH) has an open cross-section.

14. The screw connection (SV) of claim 12, further comprising an electrically insulating spacer (SD) associated with the screw head (SS1).

15. The screw connection (SV) of claim 14, wherein the spacer (SD) and the sleeve (SH) are separate components.

16. The screw connection (SV) of claim 15, wherein the spacer (SD) is made of a different material than the sleeve (SH).

17. The screw connection (SV) of claim 14, wherein the spacer (SD) has an axially aligned projection (SDX), which is aligned in a direction of the screw head (SS1).

18. The screw connection (SV) of claim 14, further comprising an additional sleeve (SH2) at least partially encompassing the screw head (SS1) and the spacer (SD).

19. The screw connection (SV) of claim 14, wherein an outer diameter of the sleeve (SH) is greater than an inner diameter of a through-hole of the spacer (SD).

20. An electric machine (EM), comprising:
a housing (GG),
wherein the electric machine (EM) is arranged within the housing (GG) and comprises a rotationally fixed stator (S) and a rotatably mounted rotor (R),
wherein the stator (S) is connected to the housing (GG) via the screw connection (SV) of claim 12.

21. The electric machine (EM) of claim 20, wherein the screw connection (SV) is aligned axially parallel to an axis of rotation (RA) of the rotor (R).

22. A drive unit (HY, HY2, G, EA) for a motor vehicle, comprising the electric machine (EM) of claim 20, wherein the electric machine (EM) is configured for propelling the motor vehicle.
